(19) United States
(12) Patent Application Publication
(10) Pub. No.: US 2002/0139781 A1
(43) Pub. Date: Oct. 3, 2002

(54) Method and apparatus for brazing and thermal processing

(76) Inventors: John O. Milewski, Santa Fe, NM (US); Vivek R. Dave, Los Alamos, NM (US); Dane Christensen, Livermore, CA (US); Robert W. Carpenter II, Santa Fe, NM (US)

Correspondence Address: Gemma Morrison Bennett, Los Alamos National Laboratory, LC/BPL, MS D412, Los Alamos, NM, 87545, US

(21) Appl. No.: 09/776,045

(22) Filed: Feb. 1, 2001

(51) Int. Cl. B23K 26/20

(52) U.S. Cl. 219/121.6; 700/166; 700/114; 700/29

(57) ABSTRACT

There has been invented a method and apparatus for heat treating or brazing joints in metals and ceramics using an optical concentrator (reflecting waveguide) to reflect energy from infrared energy heat sources, in a pattern which will provide precisely tailored illumination, heating, melting of filler and fusion of the area to be heat treated or the joint to be formed. CAD optical ray tracing software is used to custom design the reflecting waveguides for directing the energy as needed. With the invention, shorter, reduced energy heat cycles can be used to produce reliable accurate brazes, including brazes to join small diameter tubes. No furnace is necessary because localized small area brazing can be done in situ with the invention method and apparatus. Various heat sources can be used to braze various geometries, including very small diameter tubes.

This invention was made with government support under Contract No. W-7405-ENG-36 awarded by the U.S. Department of Energy. The government has certain rights in the invention.

### TECHNICAL FIELD

This invention relates to brazing or heat treating metals or ceramics using non-imaging infrared energy concentration, and more particularly the invention relates to brazing as a way of joining small diameter tubes.

### BACKGROUND ART

Berger, D. Douglas, “Vacuum Brazing Titanium to Inconel,” Welding Journal, vol. 74, No. 11, pp. 35-38, November 1995, discloses brazing techniques available for connecting tubes for a Ballistic Missile Defense program. The author states the difficulty of brazing small diameter tubes using traditional methods, but offers no solution to the problem.

Methods of using focused laser energy for narrow gap welding, such as that disclosed in U.S. Pat. No. 5,760,365, issued June 1998, have been developed, but these methods do not provide for joining methods using conventional brazing or soldering methods which do not rely on significant melting of the base materials being joined.

Conventional methods of welding can cause distortion of the material being welded due to shrinkage stresses and can result in brittle joints due to properties of the material being welded. Conventional methods of brazing can have poor economics associated with joint preparation and process automation at least partly because of relatively slow processing speeds.

Small diameter tubes and parts with complex shapes are difficult to braze since it is difficult to heat small regions precisely using state of the art induction heating or furnace heating methods. When furnace heating methods are used, time cycles to accommodate a heating up period, brazing period, and furnace cooling period are longer than those required for the localized heating enabled by use of the invention method. Also, state of the art methods make brazing of only one small area of a previously brazed object difficult since the heat cannot be narrowly focused specifically where selected. In state of the art methods, direct heating using lasers or electron beams heat from one direction only and thus will overheat one side of the joint while underheating the other side; as such, these methods are best suited for applications where a line-of-sight access to the entire joint at once is possible.

Therefore there is still a need for other methods of brazing or heat treating metal and ceramic components.

It is an object of this invention to provide a method and apparatus for thermally treating or joining articles or components by brazing with infrared energy.

It is another object of this invention to provide a method of brazing or thermally treating with non-imaging concentrations of infrared energy using reflecting waveguides for directing the concentrated energy.

It is a further object of this invention to provide an improved method of brazing or thermally treating small diameter tubes.

It is yet another object of this invention to increase efficiency of brazing processes by redirecting energy reflected from the workpiece being brazed back onto the workpiece.

It is yet a further object of this invention to provide an apparatus and method for brazing “in position” joints without having to remove the parts requiring maintainence or repair from their installed location.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### DISCLOSURE OF INVENTION

To achieve the foregoing and other objects, and in accordance with the purposes of the present invention, as embodied and broadly described herein, there has been invented a method and apparatus for brazing joints in metals and ceramics using a reflecting waveguide as an optical concentrator to reflect energy rays in a pattern which will provide precisely tailored illumination, heating, melting of filler and fusion of joints. CAD optical ray tracing software is used to custom design the reflecting waveguides for directing the energy as needed. With the invention, shorter, reduced energy heat cycles can be used to produce reliable, accurate brazes, including brazes to join small diameter tubes. No conventional furnace is necessary because localized small area brazing can be done in situ with the invention method and apparatus functioning as its own very small localized furnace.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 is a three-dimensional schematic drawing of invention placement of a tube to be brazed in a V-shaped reflecting waveguide.

FIG. 2 is a view along the longitudinal axis of a V-block reflecting waveguide depicting a non-optimal placement of the workpiece.

FIG. 3 is a view along the longitudinal axis of a V-block reflecting waveguide depicting placement of the workpiece in accordance with the invention.

FIG. 4 is a longitudinal cross section schematic of two tubes positioned for a braze to be made between the tubes.

FIG. 5 is a schematic of the tubes of FIG. 4 positioned within a conical reflecting waveguide.

FIG. 6 is a schematic of the rays impinging the tubes of FIG. 4 positioned within a conical reflecting waveguide as shown in FIG. 5.

FIG. 7 is a graph of the energy absorbed by the larger tube shown in FIG. 6.

FIG. 8 is a graph of the energy absorbed by the smaller tube shown in FIG. 6.

FIG. 9 is a cross section of a joint resulting from the brazing operation shown in FIGS. 1-8.

FIG. 10 is a schematic showing placement of a conical reflecting waveguide in a tube to be brazed into a plate.

FIG. 11 is a cross section of a joint made using the invention embodiment shown in FIG. 10.

FIG. 12 is a schematic of a cross section of a braze to be made in a gap between the leading edges of each of two plates with the angled edges of the tube plates being used as the reflecting waveguide.

FIG. 13 is a schematic of a cross section of a braze to be made between a tube or rod and a plate in which surfaces of the tube or rod and the plate serve as the reflecting waveguide.

FIG. 14 is a schematic of a cross section of a braze to be made between two tubes or rods in which surfaces of the tubes or rods serve as the reflecting waveguide.

FIG. 15 is a schematic cross section of a braze to be made between a tube or rod and a plate in which both surfaces of the tube or rod and the plate and a separate reflecting waveguide are used in combination to serve the function of the reflecting waveguide.

FIG. 16 is a schematic cross section of a braze to be made between two tubes or rods in which both surfaces of the tubes or rods and a separate reflecting waveguide are used in combination to serve the function of the reflecting waveguide.

FIG. 17 is a schematic of a typical invention setup.

### BEST MODES FOR CARRYING OUT THE INVENTION

It has been discovered that particular configurations of reflecting waveguides combined with the particular reflective properties, part and joint geometries and spatial orientations of workpieces with respect to the surfaces of the reflecting waveguides can be designed to focus and concentrate infrared energy to braze or thermally treat any of a large variety of sizes, shapes or materials of components more effectively than previously possible. The invention method and apparatus is particularly useful for brazing joints in small diameter tubes.

In the invention method and apparatus, non-imaging infrared energy concentration (or non-imaging optical energy concentration) is accomplished by use of reflecting waveguides to concentrate incident radiant energy and reflective loss energy through multiple reflections in such a way as to increase the density of rays striking each targeted unit area of an object located inside the reflecting waveguide.

Precise placement of the workpiece within the reflecting waveguide and optimally selected waveguide shape enable precisely tailored application of heat needed for brazing complex shapes, small localized areas, or small parts such as small diameter tubes. The reflecting waveguide configurations, energy characterizations, and positions of parts to be brazed or thermally treated are analyzed and optimized by using computer modeling and can be tailored for a great variety of complex or simple geometries and sizes of parts, sizes of braze regions and for various heat sources in varied work environments.

The invention is practiced by:

(a) determining the shape of the workpiece to be thermally treated or brazed;

(b) determining the shape of the braze joint and filler material;

(b) determining the time and temperature profile needed for the process;

(c) selecting an energy source which can provide the energy needed;

(d) selecting an approximated configuration for a reflecting waveguide;

(e) selecting an approximate placement of the workpiece in relation to the waveguide;

(f) entering data for (a), (b), (c), (d) and (e) into a computer model with ray tracing software;

(g) running the computer model to obtain a quantitative assessment of the energy flux distribution on the workpiece;

(h) entering selected variables in the configuration of the workpiece, the position of the workpiece, or the energy supplied into the computer model;

(i) running the computer model again to obtain another quantitative assessment of the energy flux distribution on the workpiece;

(j) reiterating steps (f) through (i) until a set of variables which will give the optimized energy flux distribution is determined;

(k) setting up the work using the computer generated configuration for the reflecting waveguide, position of the part, and energy profile; and

(l) performing the work.

The invention apparatus comprises (a) an energy source and associated optics as needed to provide infrared radiation or other radiant energy to (b) the reflecting waveguide within which (c) the workpiece is positioned using holders or fixtures as needed. Depending upon workpiece and waveguide shapes, the waveguide can also serve as the positioning fixture. A processing chamber, temperature sensors, and control systems as needed are employed, depending upon the types of workpiece base materials and filler materials specified and kind of work to be done. Processing consumables such as braze materials, flux, active or inert shielding gaskets are employed as needed.

The time and temperature profile needed for the joining process is determined by conventional methods. This is usually done by considering such things as the brazing or soldering alloy to be used, the melting range of the alloy, the clearance or gap available for the braze alloy to flow and the mass or geometry of the workpiece.

The energy flux that is required to produce the desired thermal profile can be determined by using prior experience, through approximate engineering calculations, or through finite element modeling or other numerical analysis techniques. The system can also be solved as an inverse problem using an optimization method such as genetic algorithms to systematically alter parameters in the flux distribution until the desired thermal profile is obtained. The specifications of the energy sources can be compared with the energy flux required.

Any of various energy sources such as solid state or gas lasers, diode lasers, and other infrared sources, can be used in the invention method and apparatus to provide energy for brazing any metals, ceramics, or metal to ceramic combinations using the invention method and apparatus. Commercially available gas lasers are presently preferred for applications requiring large amounts of beam power.

Solid state and diode pumped lasers are useful because of the better coupling of the characteristic wave lengths of these lasers to metals and because of the high average power capability and high beam quality for relatively compact systems available from solid state and diode pumped lasers. Relatively compact systems with high beam quality are particularly useful for joining of large assemblies where optical fiber and collimated beam delivery allows flexible and remote configurations.

Direct diode lasers available with increased power, lower costs, longer lifetimes and very compact sizes are also useful in the invention because shortcomings with respect to beam quality and focal spot size limitations can be offset by optimization of the energy concentrators achieved by this invention.

Other infrared energy sources offer the lowest cost options as portable suppliers of energy. The inferior optical characteristics of these systems are offset by the invention concentrator system design which provides a low cost alternative to costly laser imaging optics in a compact portable package.

The cost and nature of the heat source are also considered in selecting the wave lengths, frequencies, pulse widths and peak power to be used.

The wave lengths, frequencies, pulse widths and peak power have an effect upon the thermal conditions achieved and therefore must be considered along with the geometric designs of parts that can be processed and the design of the reflecting waveguides which can be used.

The energy reflecting waveguide redirects the radiant energy impinging upon the reflecting waveguide and part or workpiece so that the impinging energy undergoes multiple reflections between the part and the reflective surfaces of the reflecting waveguide which functions as the optical concentrator. The energy is redistributed and recycled back onto the part by the multiple reflection and absorption events.

The approximated configuration and preliminary material selection for a reflecting waveguide can be selected by using a variety of critera. Depending upon what is important in the particular type of joining or brazing or heat treating being done and purpose of the work, reflector shape and material selection criteria can include the following: consideration of the size and shape of the parts to be joined; commercial availability of the shapes of the appropriate reflector materials; shapes that are attainable through common forming and machine tooling; shapes that are attainable as free forms through methods such as sculpting, casting or spraying; cost and complexity of the reflector and fabrication methods available; knowledge of shapes of lenses, reflection and non-imaging optics to provide the starting point for further reiterations; and availability of algorithms for a particular shape to optimize the shape in further reiterations.

The reflecting waveguides useful in the invention are those made from materials which reflect the impinging energy onto the part to be brazed. Materials which can be used for the reflecting waveguides include, but are not limited to, copper, alumina ceramic, aluminum, silver, gold, silver plated material, and gold plated material.

The reflecting waveguides are shaped as needed to provide precise, tailored, even illumination, heating, melting of braze filler and fusion of the joint. The shape of the reflecting waveguide is optimized in subsequent invention steps through iterative means, i.e., a shape and position are modeled or tested, then adjusted to further improve the distribution of the energy pattern and contact with the part or parts being joined.

The position of the parts to be thermally processed or joined relative to the reflecting waveguide is selected by: consideration of the size and shape of the parts to be joined; cost and complexity of the positioning equipment needed; knowledge of shapes of lenses and mirrors, reflective and non-imaging optics to provide the starting point for the further reiterations; and availability of algorithms for a particular shape to optimize the position of the parts having that shape in further reiterations.

The presently preferred method of optimizing the reflecting waveguide configuration, the position of the workpiece, the energy flux, and any other selected variables is by use of a three-dimensional CAD optical design program with a non-sequential optical ray tracing algorithm such as the OptiCAD™. The computer model generated using this software allows rendering of the selected geometry of the proposed brazing area or joint, the characteristics of the energy beam, and the geometry of the optical concentrator to be held constant or varied to select the optimums to be used for any particular joining or heat treating task.

Models which perform finite element analysis of heat flow can be used to evaluate the selection of reflector shape and position of the parts to be thermally treated or joined.

The quantitative assessment of the energy flux distribution on the workpiece can be output using any suitable method. Presently preferred is displaying the energy output by graphing the spatial heat flux data using commercially available computer software such as Microsoft EXCEL™. The Microsoft EXCEL™ can also be used to calculate the total energy absorption by the workpiece and determine the uniformity of surface illumination.

Then, in a trial and error method, multiple iterations of the model with selected variations on the parameters are run until a satisfactory resulting shape for the reflecting waveguide is associated with a selected energy flux distribution for accomplishing the work.

For example, a computer model which will provide a 3-D CAD, non-imaging optical design, such as OptiCAD™ optical ray tracing software package can be used on a PC or workstation to model the geometric parameters of the system of the part or parts to be thermally treated or joined and the reflecting waveguide serving as the optical concentrator. Reflecting waveguides, a braze joint assembly and a radiant energy source are modeled. The size, location and orientation of each component are adjustable within the model. The model also can represent the energy source as either a distributed collimated beam formed by an array of point sources or as a localized focused beam point source with adjustable divergence and energy.

The energy sources provide a distribution of rays, each of which carries a specific amount of energy that is deposited upon the surfaces of the reflecting waveguide and the part to be thermally treated or joined where the rays impinge. These surfaces are made up of an absorptive feature which records the location of the ray impingement and amount of energy deposited and a reflective feature which directs the unabsorbed remainder of energy back into three-dimensional space where it is either lost or impinges upon the reflecting waveguide and is re-reflected or reconcentrated back onto the braze joint region. The amounts of energy absorbed and reflected are modeled in three dimensions.

The non-sequential ray tracing of the model allows for modeling of rays impinging upon any surface in any order. As the rays propagate throughout the model, the rays give up energy as they contact surfaces until they lose substantially all of their original energy and are then terminated from consideration within the model. To obtain an adequate statistical representation of energy propagation, typically 10,000 rays are traced over a distribution of space defined by the radiant energy source. In these models, the reflective surfaces of the reflecting waveguides are defined to have a reflective coefficient associated with the particular metal, e.g., a reflective coefficient of 98% for copper. Energy absorption is not typically recorded for the reflecting waveguide surfaces, although it may be recorded to optimize the reflector design, e.g., to minimize the reflector size.

The sections of a workpiece such as a tube to be joined are defined in the model as possessing energy absorption values and reflective values consistent with those known for the material of which they are made. For example, typical for the Nd:YAG wavelength impinging directly upon stainless steel, an energy absorption value of 35%, and conversely, a reflective value of 65%, is assigned. Therefore, energy impinging upon the tube section can reflect back onto the walls and back onto the tube multiple times, allowing multiple absorption opportunities.

Within the three-dimensional model, a mesh of absorptive detector units which record the location and intensity of energy deposited (not reflected) for all impinging rays lies beneath the partially reflective walls of the tube geometry.

Braze filler “preform” geometry does not necessarily have to be considered in the model. Angle-dependent absorption, beam polarization, and scattering are also considered to have only secondary effects and to make little contribution to the accuracy of the model.

Because the invention method and apparatus is primarily for the purpose of even distribution of incident radiant energy at a selected thermal profile onto an absorbing surface, the issues of efficiency of collection and efficiency of transmission are not as significant in calculating the optimal configuration of the reflecting waveguide or placement of the workpiece.

The use of the models provides insight and direction for experimental trials and for practical and production operation of the invention.

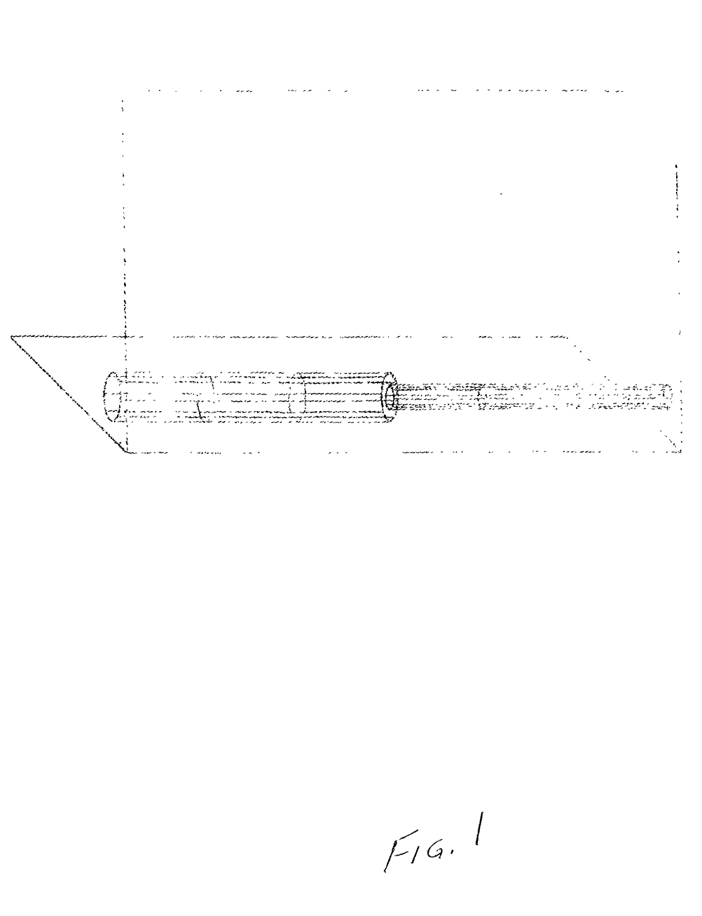

V-shaped reflecting waveguides are useful for processing a variety of workpiece shapes. For example, as shown in FIG. 1, a reflecting waveguide can consist simply of a V-block having any of a great variety of dimensions. For one example, a V-block length of about 2 inches, a height of about 1 inch, and an included angle of 72° can be used for a common-sized tube having a diameter of 0.060 inches and a length of 2 inches. The part is positioned longitudinally within but not touching the inside of the angle of the V-block.

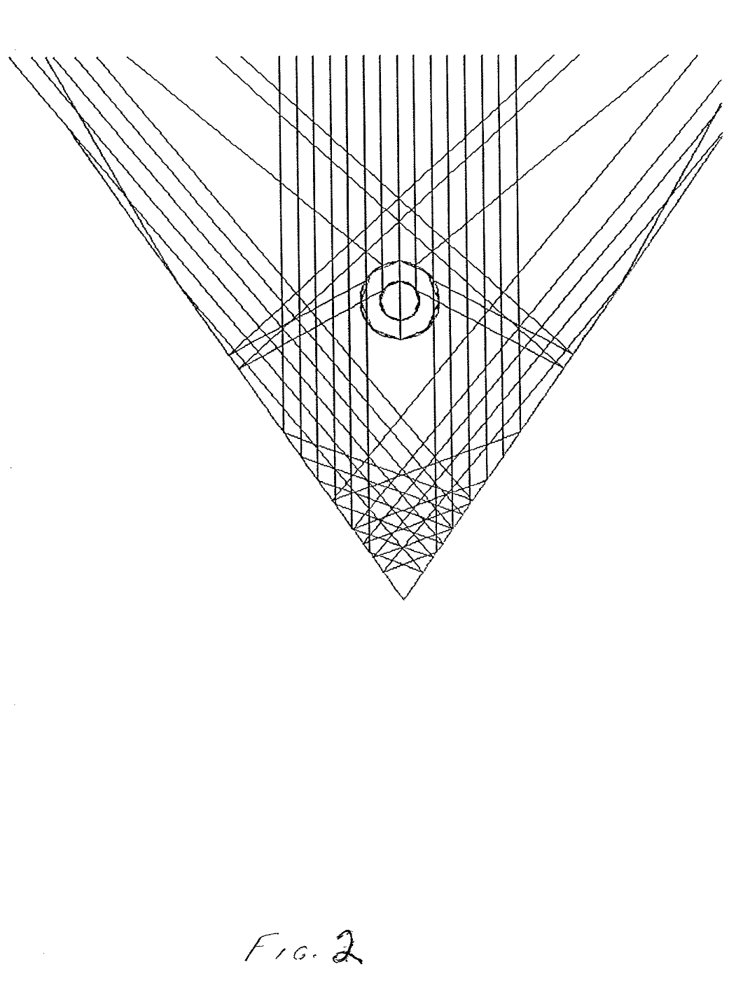

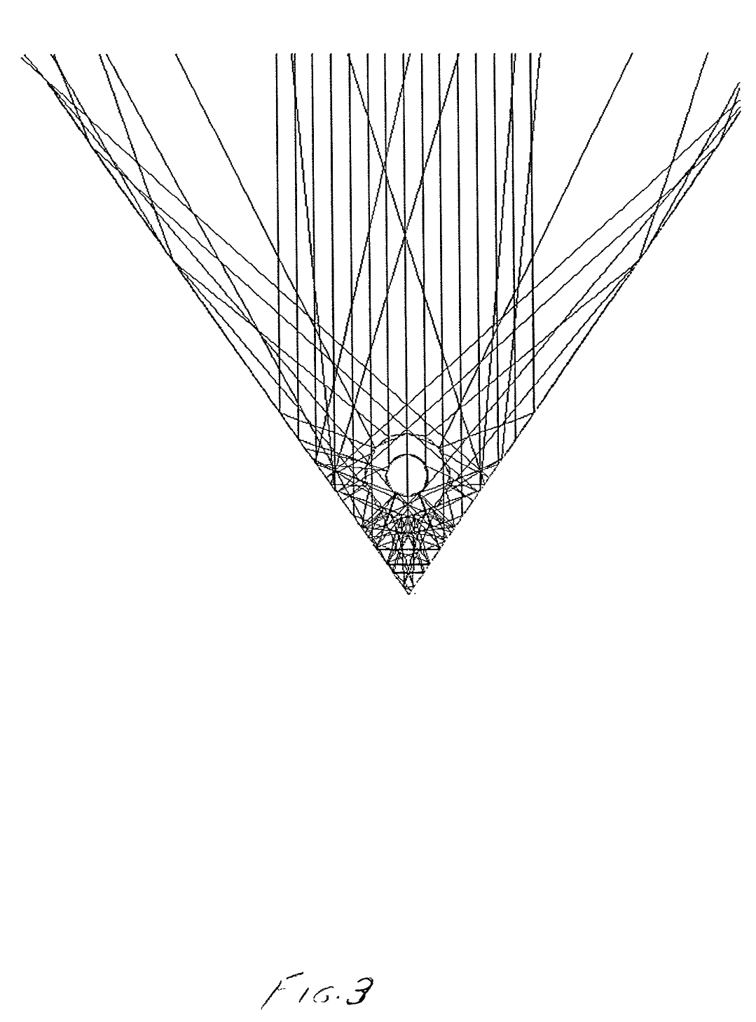

FIGS. 2 and 3 show the spatial relationship of tubes to be joined to a V-block reflecting waveguide as viewed along the longitudinal axis of the V-block, i.e., with a view looking down the length of the tubes to be joined. The diagonal lines in each of FIGS. 2 and 3 show the paths of energy rays into the V-block. As shown in FIG. 2, a random placement of the tubes to be joined results in less than the best distribution of energy application to the tubes to be joined because of the pattern of the incidence of the energy rays striking the tubes and the reflecting waveguide. As shown in FIG. 2, with this particular random placement of the tubes to be joined within the V-block, the incident rays strike the tops of the tubes, but essentially no rays are reflected in such a way as to strike the bottoms of the tubes. This causes uneven heating conditions and results in poor joint formation or inadequate heat treatment. FIG. 3 shows an invention arrangement in which the tubes are positioned with respect to the V-block so that the incidence of energy rays is more evenly distributed over the entire circumference of the tubes, thereby providing a much more nearly uniform density of energy rays impinging on the tube surfaces.

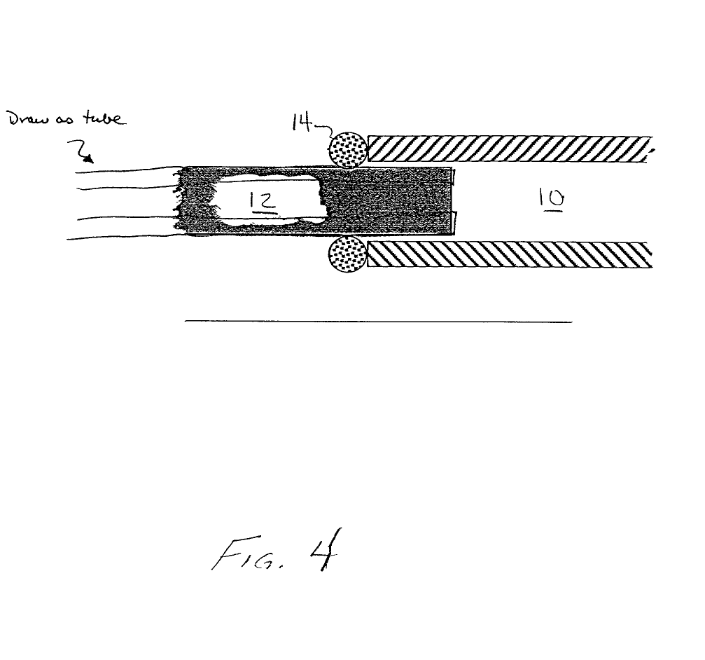

Another example of a typical invention setup is shown in FIGS. 4, 5 and 6. FIG. 4 shows tubes positioned in a setup for a braze between a larger tube 10 and a smaller tube 12 inserted into the end of the larger tube 10. The braze filler material 14 is in the shape of a ring that goes around the circumference of the smaller tube 10 and rests against the end of the smaller tube 110.

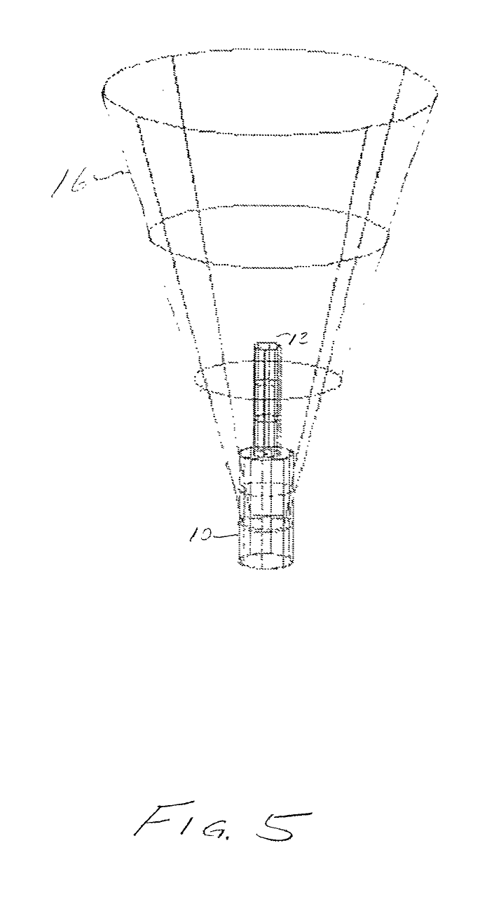

As shown in the diagram of FIG. 5, a conical reflecting waveguide 16 is selected for the brazing. The larger tube 10 and the smaller tube 12 are positioned so that the places where the tubes 10 and 12 to be joined is within the conical reflecting waveguide 16.

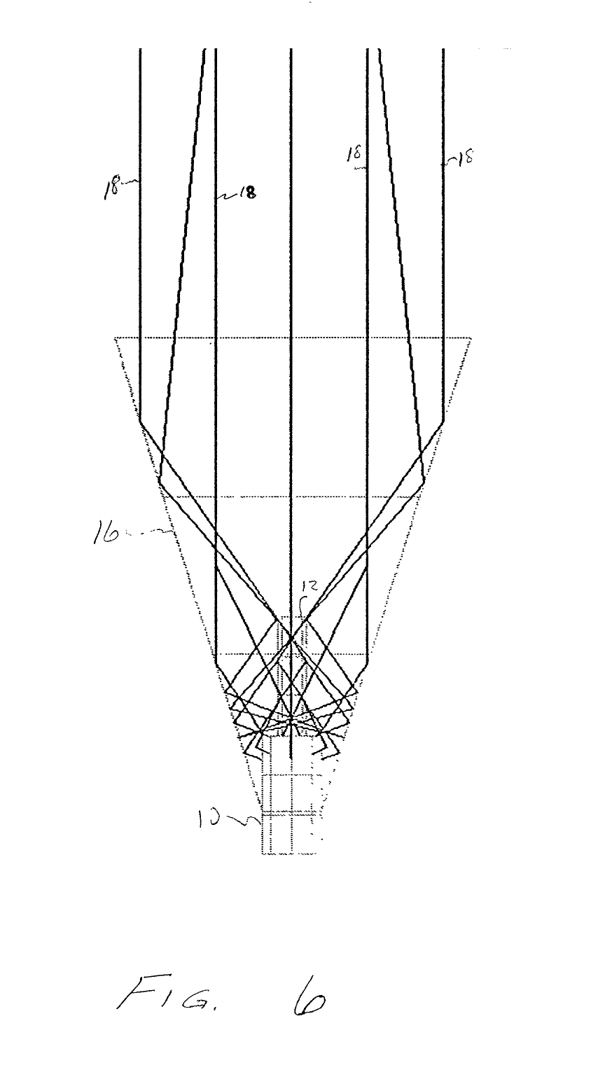

FIG. 6 shows the pattern of the energy rays impinging upon the tubes 10 and 12 of FIG. 5 in a three-dimensional meridional view through a plane passing through the centerline of the tubes 10 and 12 and the reflecting waveguide 16. Energy rays 18 from the power source impinge the surfaces of the conical reflecting waveguide 16 and the tubes 10 and 12 as shown in FIG. 6. It can be seen from the diagram of FIG. 6 that multiple reflections of the energy occur from the conical reflecting waveguide 16 to the tubes 10 and 12 and back again so that energy is reused as it is recycled within the conical reflecting waveguide 16.

In the model of the setup in FIGS. 4, 5 and 6, the position of the part within the reflector is adjusted, and for each simulation, the energy flux impinging on the part surfaces is recorded.

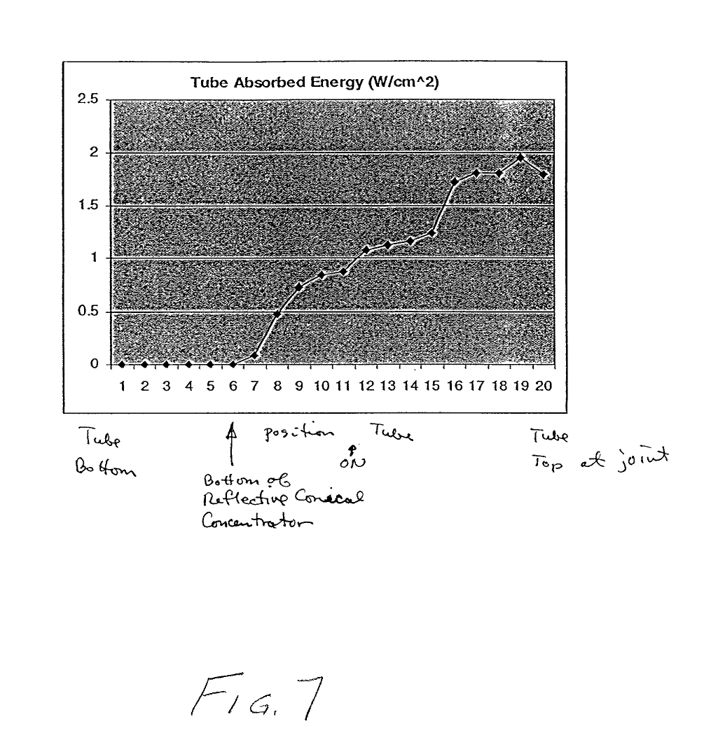

FIG. 7 is a graph of the energy absorbed by the larger tube 10 as a function of location along the length of the tube 10. The numbers along the horizontal axis of the graph indicate the relative position along the tube, with 0 starting at the bottom of the tube and 20 being at the top of the tube where the joint is brazed. The bottom of the reflective cone is at the position 6 where the energy begins to be absorbed.

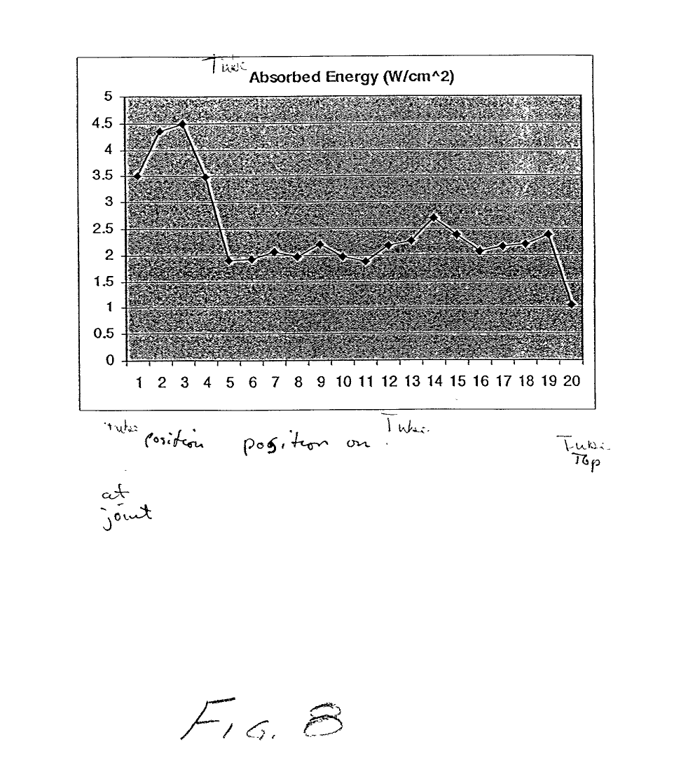

FIG. 8 is a graph of the energy absorbed by the smaller tube 12 as a function of location along the length of the smaller tube 12. As in the previous graph, the numbers along the horizontal axis of the graph indicate the relative position along the tube; but 0 is at the end of the tube at the braze joint and 20 is at the top of the tube, the end opposite the end where the braze joint is.

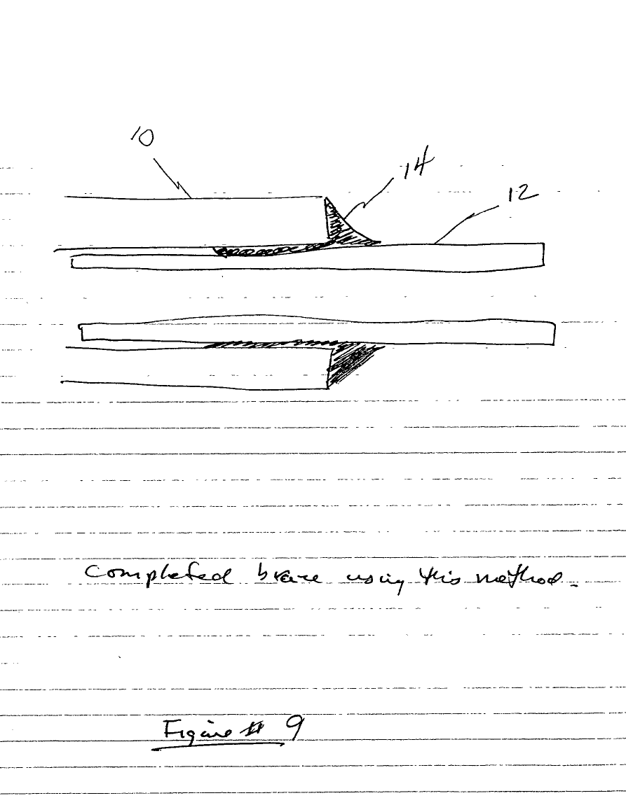

FIG. 9 shows a cross section of a joint which has been brazed in accordance with the embodiment of the invention shown in FIGS. 4-8. In FIG. 9 it can be seen where the heated braze material 14 has filled in the gap between the larger tube 10 and the smaller tube 12.

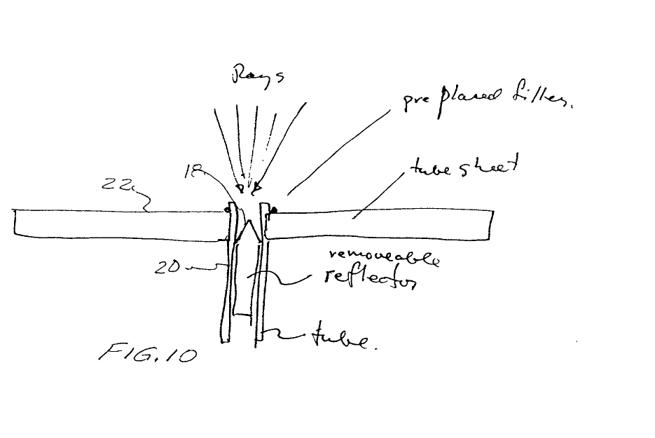

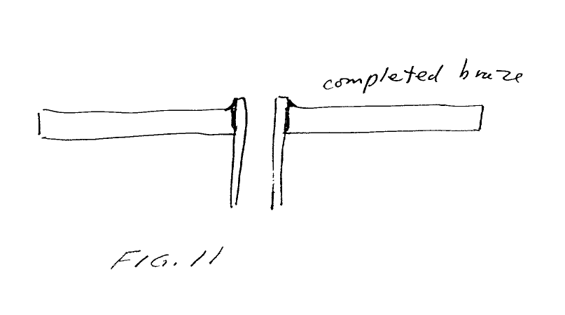

For yet another example, shown in the schematic of FIG. 10, an inverted cone shaped reflecting waveguide 18 can be positioned within a tube 20 which is to be brazed into a tube sheet 22. The laser beam enters the tube and is reflected by the tube walls and from the inverted cone shaped reflecting waveguide 18 to internally heat the tube 20. This reflection and distribution of the energy waves provides even heating needed for brazing the tube 20 into the tube sheet 22. The inverted cone shaped waveguide surface is designed to be at the particular angle relative to the walls of the tube to be brazed which will optimize the laser energy contact with, and the location of, energy absorption in the area to be brazed. FIG. 11 shows a joint made with this method without the use of filler, melting only the base material to create the braze.

Other configurations of reflecting waveguides can be used for brazing or heat treating parts having other shapes, such as elipsoid or square cross sections. Reflecting waveguides, including conical and V-shaped ones, can have concave or convex surfaces to achieve better energy distribution patterns on workpieces with complex shapes.

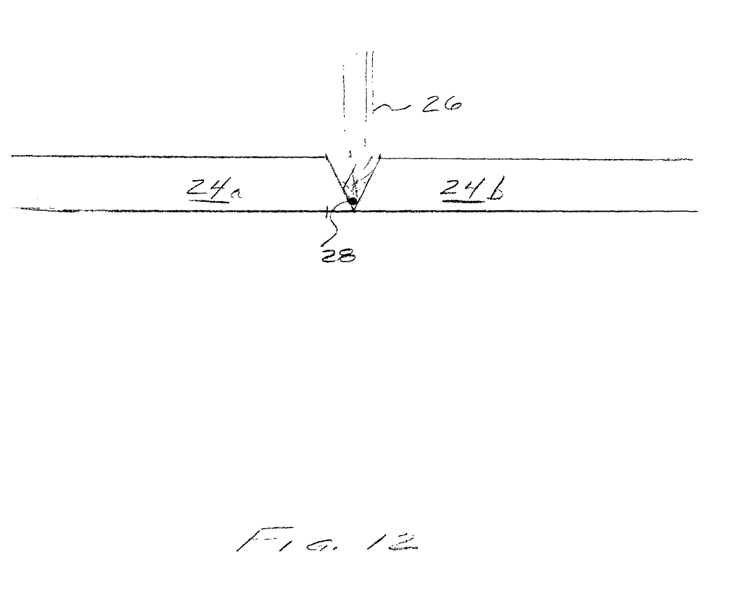

For some applications some surfaces of the part to be heat treated or brazed serve as the reflecting waveguide. For example, when a joint is to be brazed into a gap between the abutting edges of two sheets, the angles at which the sheet edges are cut serve as reflecting angles to concentrate the optical energy into the braze filler and onto the sheets. This use of surfaces of the part as a reflecting waveguide is shown in FIG. 12. The angle of the edges of the sheets 24, reflect rays 26 onto the braze material 28.

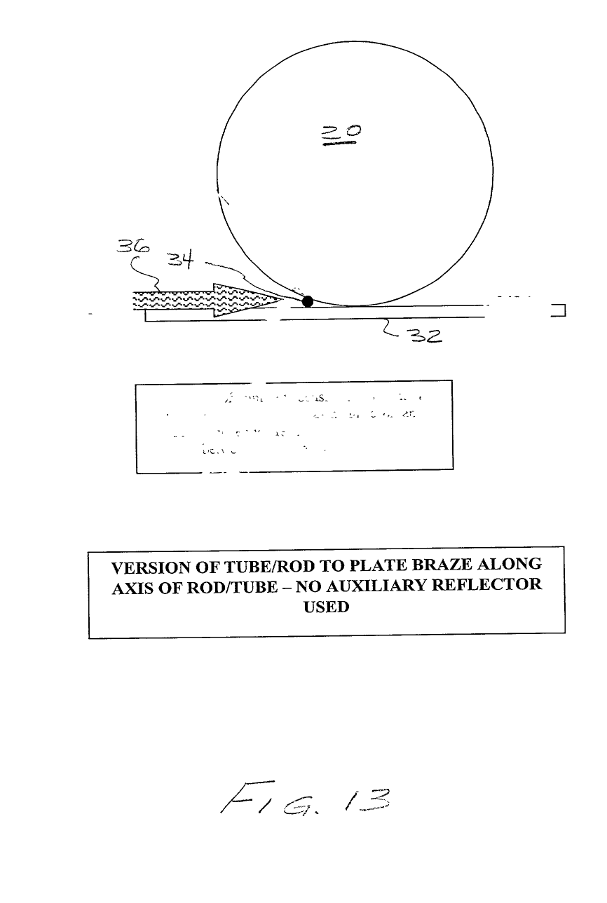

In another example of use surfaces of the parts comprising the workpiece as reflecting waveguides, the invention method may be employed to braze a tube or rod to a plate as shown in the schematic cross section of FIG. 13. In FIG. 13, a tube or rod 30 is brazed to a plate 32 using a braze filler material 34 by focusing energy rays 36 such that the surfaces of the tube or rod 30 and the plate 32 serve as the reflecting waveguides.

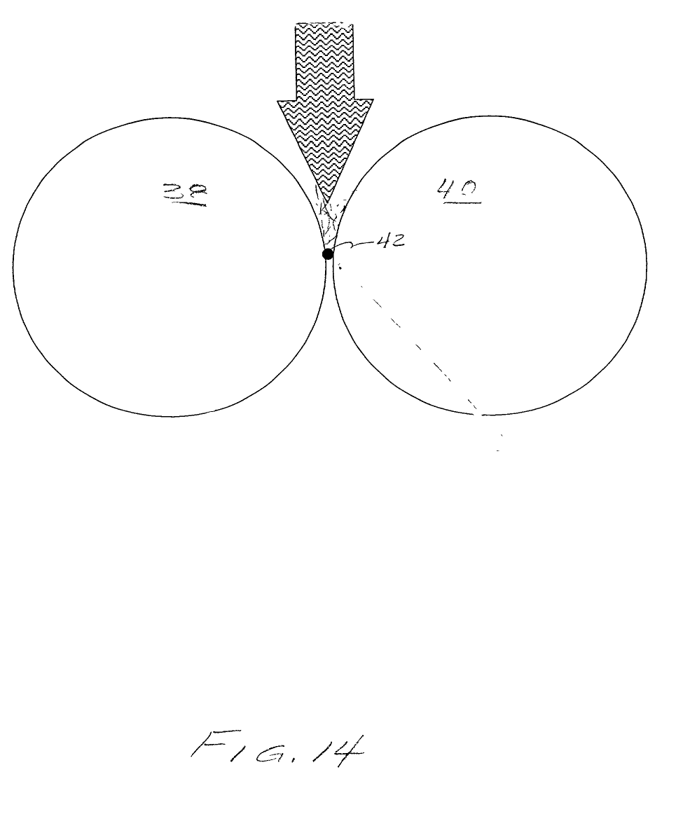

In a similar example shown in the schematic cross section of FIG. 14, the surfaces of each of two tubes or rods 38 and 40 are brazed together using filler material 42 and focusing the energy rays such that the surfaces of the tubes or rods 38 and 40 serve as the reflecting waveguides.

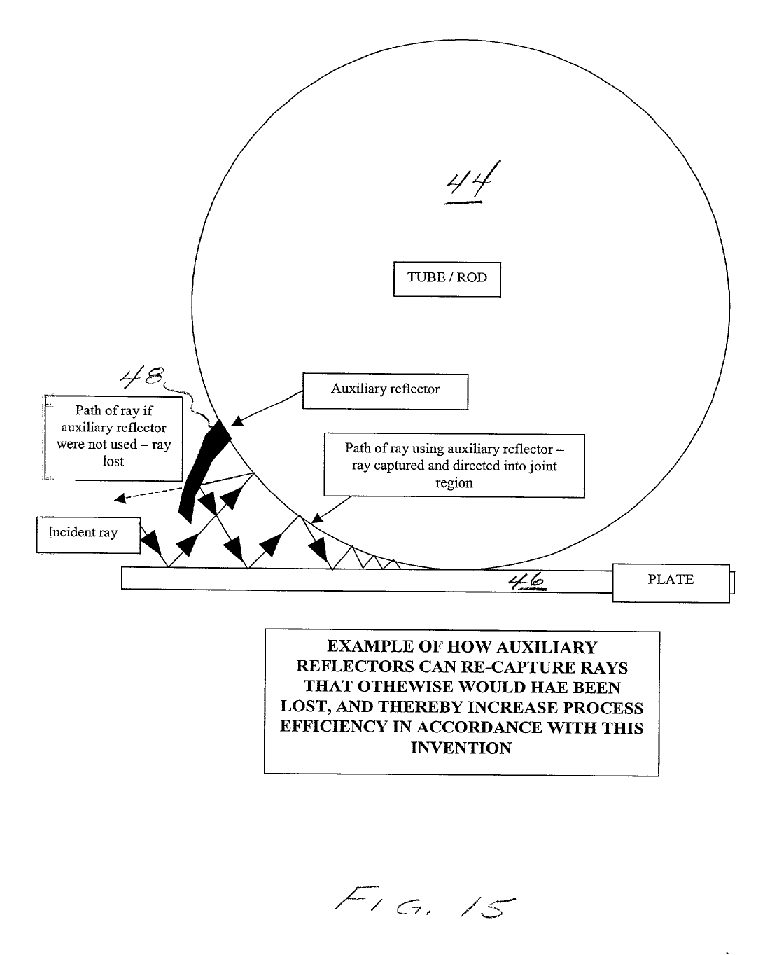

In other applications of the invention apparatus and method, a combination of use of one or more reflecting waveguides and surface or surfaces of the workpiece consisting of the parts to be brazed can be used for optical concentration of the energy. One example of this is shown in the schematic cross section of FIG. 15 where a tube or rod 44 is brazed to a plate 46 using both the surfaces of the tube or rod 44 and the plate 46 and a reflecting waveguide 48 shaped and positioned in accordance with the invention method to effectively direct the energy as needed.

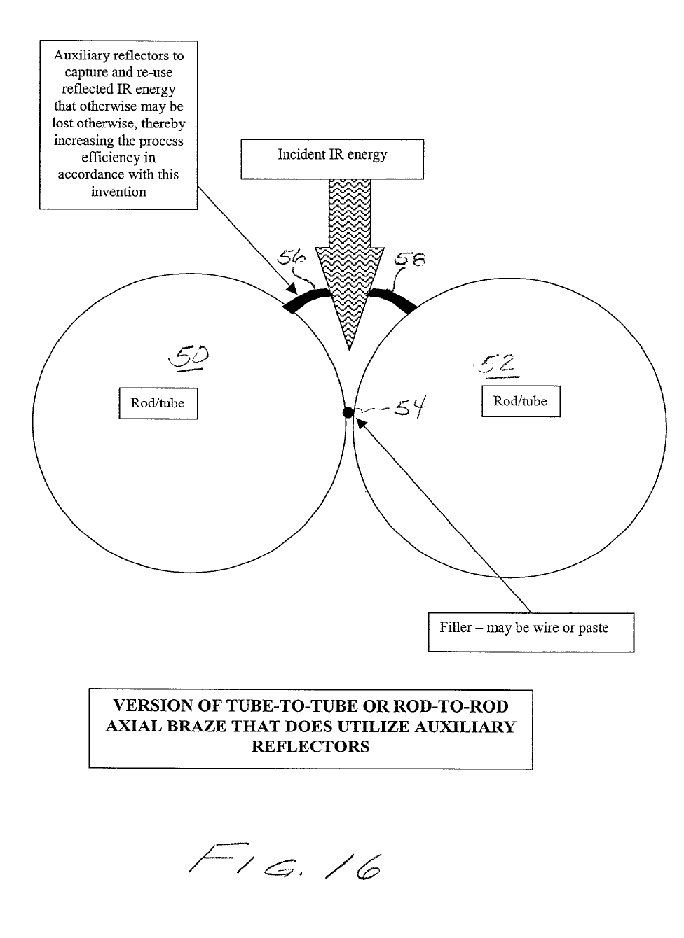

Another example of a combination use of one or more reflecting waveguides and surface or surfaces of the workpiece consisting of the parts to be brazed is shown in the schematic cross section of FIG. 16. Two tubes or rods 50 and 52 are brazed with braze filler material 54, using two reflecting waveguides 56 and 58 to capture and re-use energy rays reflected from the surfaces of the two tubes or rods 50 and 52.

If it is desired to use an inert gas for shielding the braze process, backfill atmosphere chambers with glass windows and integral reflecting waveguides can be used for containing and reflecting the energy for impinging precisely on the parts to be brazed or heat treated. An example of this is a clam-shaped, handheld-sized chamber which can be clamped over the portion of a fixed line to be brazed and a suitcase-sized portable laser power supply.

Rapid, even heating of parts at low cost is achieved using the invention apparatuses and processes. Use of the invention permits shorter, reduced energy heat cycles to accomplish the same work, which is particularly useful for production environments or to minimize the reaction between braze metal and base metal. No conventional furnace is necessary—localized small area brazing can be done in situ, which is particularly usefull for braze repair of fixed parts without affecting other nearby existing brazed or soldered joints.

The invention can be used for a large variety of part geometries and joint geometries. For example, the invention apparatus and process can be used to make tubular lap joints, plate edge joints, pin hole joints, stud-to-plate connections, hole plugging, butt joints, tube-to-tube sheet joints, tube-to-flange joints, wire splices, and heat treatment of edges, wires and tubes.

A large variety of materials can be heat treated or brazed using the invention method and apparatus. These include, but are not limited to, ferrous alloys, nickel base alloys, refractory metals, precious metals, reactive metals, aluminum alloys, copper alloys, glass, aluminum, zirconia, and composite materials. The invention apparatus and process can be employed for other treatments of heat treatable materials, such as for hardening and quenching and annealing of glass-to-metal seals.

The following examples will demonstrate the operability of the invention.

### EXAMPLE I

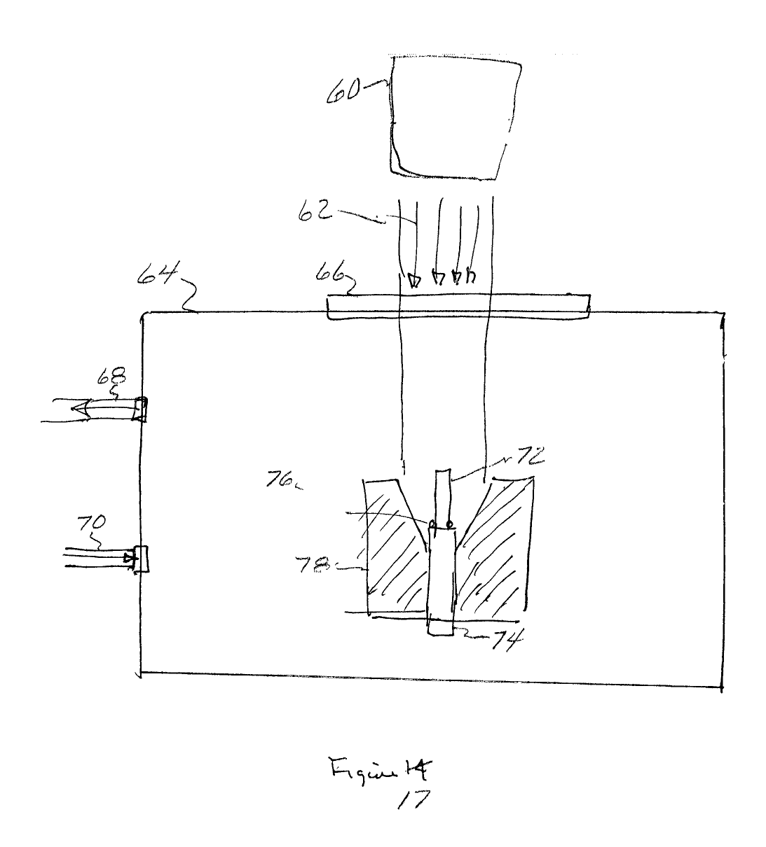

To prove operability of the invention two tubes were brazed together, with an end of one inside an end of a slightly larger tube. In one set of runs a conical reflecting waveguide was used and in a second set of runs a V-block (wedge shaped) reflecting waveguide was used. The laser and test chamber were set up as shown in the line drawing of FIG. 17.

A Raytheon™ SS-500 400-watt average power pulsed Nd:YAG laser with hard optics beam delivery was used as an infrared energy source 60. The final focus lens was removed to allow the use of the 0.4″ diameter columinated laser beam 62.

The test chamber 64 was a stainless steel box with a 2″ diameter quartz glass window 66. A roughing pump port 68 and process atmosphere inlet 70 were provided to allow the pump down and backfill of the chamber to reduce the oxygen and moisture in the chamber to acceptable processing levels.

An argon with 6% hydrogen gas mixture, commercially available as welding gas, was used to shield the molten braze material from oxygen and to create a partially active braze environment where the hydrogen gas reacted with residual surface oxides to help clean the joint and improve molten metal wetting.

The tubes 72 and 74 to be brazed in each run were 304 stainless steel, one tube 72 with a 0.063-inch (1.6 mm) outside diameter and a second tube 74 with a 0.125-inch (3.18 mm) outside diameter. The smaller tube 72 was placed concentrically within the larger tube 74, resulting in a concentric gap of approximately 0.005 inches (0.127 mm).

The braze material 76 was 0.025 inch (0.635 mm) diameter Nioro™ (Au—18% Ni) wire cut and formed into 2 rings. Both the tubes and rings were cleaned using alkali cleaner followed by deionized water rinsing, and were given a final rinse in high purity ethanol immediately prior to assembly and brazing.

The reflecting waveguides were polished copper. The conical-shaped reflecting waveguide 78 is shown in the schematic of FIG. 17. The V-shaped reflecting waveguide was as shown in FIGS. 1, 2 and 3.

Models were run on a Pentium III laptop running Windows NT using an OptiCad™ optical ray tracing software package. The models employed non-sequential ray tracing which allowed a ray to impact any surface in any order. To obtain an adequate statistical representation of energy propagation, 10,000 rays were traced as emanating from a region of space defined by a distribution of point sources of rays representing the actual distributed heat source object of the collimnated laser beam source.

The reflective surfaces of the copper waveguides were defined to have a reflective coefficient of 98%. No energy absorption was recorded for the reflecting waveguide walls. The tube sections were defined to possess an energy absorption value of 35%, typical for Nd:YAG radiation on stainless steel, and conversely, a reflective value of 65%.

The tracing of 10,000 rays required approximately 2 minutes run time. The total energy input into the system is distributed evenly among the number of rays specified. In initial trials, variations in V-block and cone geometry, laser beam size and location, and tube joint location were made to develop a qualitative appreciation for the interaction of these parameters and a quantitative output of energy absorption versus position of the braze joint.

Energy output of the models was displayed by graphing the absorptive data using Microsoft™ EXCEL. The Microsoft™ EXCEL software was also used to calculate total energy absorption by the tubes and to determine the uniformity of tube surface illumination.

The tubular test samples with braze alloy ring preforms were placed within the reflecting waveguide at locations indicated by the preliminary model results. The tubular test samples within the reflecting waveguides were then positioned beneath the test chamber window to allow direct delivery of the laser beam into the reflecting waveguide.

When the conical reflecting waveguide was used, the final focusing lens of the laser was not used, thereby allowing the approximately 0.4-inch (10 mm) beam to pass through the test chamber window directly into the conical reflecting waveguide. Omitting the final focusing lens of the laser eliminated one variable from the system, i.e., that of laser focal length, and allowed greater access to the experimental setup.

When the V-block shaped reflecting waveguide was used, a beam aperture external to the laser cavity was used to reduce the diameter of the beam in order to reduce the extent of braze joint illumination and heating.

Various V-block and cone angles were modeled. Focused and collimated beams at various locations and of various diameters were also modeled. The position of the tube joint within the reflecting waveguide was also modeled.

The model predicted that a part location with the center of the tubes 0.35 inches (8.9 mm) from the bottom of the V-block would result in the most even circumferential illumination around the joint circumference.

The parameters used to perform the brazes are given in Table 1.

TABLE 1
Laser and Process Parameters

| | V-block | Conical |
|---|---|---|
| Parameter | reflecting waveguide | reflecting waveguide |
| laser power | 75 W | 75 W |
| pulse length | 7.2 msec | 7.2 msec |
| repetition rate | 50 pps | 50 pps |
| beam diameter | 10 mm | 3 mm |
| beam aperture | none | 0.170 inch |
| shield gas | argon/6% hydrogen | argon/6% hydrogen |
| illumination time | 30 sec | 80-100 sec |

Braze illumination was initiated, watched to observe braze wetting and flow, then ended. The tubes were observed to heat rapidly and evenly all the way to brazing temperature within 30 seconds in the case of the V-block shaped reflecting waveguide and 100 seconds in the case of the cone shaped reflecting waveguide at 75 W incident power.

A control run was made without a reflecting waveguide using only direct laser beam energy impingement. Without the reflecting waveguide, the tubes failed to reach brazing temperatures regardless of the duration of energy input at 75 W incident power.

Samples were visually inspected, helium-leak checked to ensure hermeticity, macro photographed, and metallographically examined using standard procedures.

The ray tracing models proved useful in visualization of energy impingement as a function of reflecting waveguide geometry, tube joint location and energy source geometry.

With the non-optimized placement of the tubes within the V-block reflecting waveguide, as shown in FIG. 2, energy flux concentrated below the tubes rather than impinging on the tubes in an evenly distributed pattern.

FIG. 3 shows an optimized placement of the tubes within the V-block reflecting waveguide; with this placement there was even illumination on all sides of the tubes by direct and reflected rays providing for maximum energy absorption by the tubes.

Brazes optimized in accordance with the invention displayed a bright, smooth, even and continuous fillet around the circumferences of the joints. The cross sections showed good continuous wetting and capillary flow within the braze joint with no indication of overheating or internetallic formation. The as-received microstructure of the tubing showed no alteration or detrimental effects on grain size due to the short thermal cycles achieved by the practice of this invention. No alternation to the surface of the tubing such as localized melting or oxidation due to direct beam impingement was observed. Liquid metal embrittlement of the base material which can result from overheating due to excessive energy intensity or duration was also avoided by use of the invention method and apparatus.

While the apparatuses, articles of manufacture and methods of this invention have been described in detail for the purpose of illustration, the inventive apparatuses, articles of manufacture and methods are not to be construed as limited thereby. The claims of this patent are intended to cover all changes and modifications within the spirit and scope thereof.

### INDUSTRIAL APPLICABILITY

The invention has applications in rebuilding and manufacturing of weapons components and in field retrofit of small tubing and tubulation hardware. Industrial applications can be made in aerospace, commercial jet turbine engine repair, electronic component manufacturing, medical fields, or anywhere small precise part brazing is needed.

What is claimed is:

1. An apparatus for brazing joints in metals and ceramics, said apparatus comprising:
(a) a radiant energy source; and
(b) a reflecting waveguide to direct and redirect beams from said energy source onto a workpiece;
wherein said reflecting waveguide is shaped and said workpiece is positioned to optimize the energy pattern on and within said workpiece.

2. The apparatus of claim 1 further comprising:
(c) a part holder to hold said workpiece in position to be contacted with said energy beams.

3. The apparatus of claim 1 wherein said reflecting waveguide is V-shaped.

4. The apparatus of claim 1 wherein said reflecting waveguide is conically shaped.

5. The apparatus of claim 1 wherein said reflecting waveguide is V-shaped with curved walls.

6. The apparatus of claim 1 wherein said reflecting waveguide is a cone with outwardly curved walls.

7. The apparatus of claim 1 wherein said reflecting waveguide is a cone with inwardly curved walls.

8. The apparatus of claim 1 wherein said reflecting waveguide is a complex surface.

9. The apparatus of claim 1 wherein a portion of the surface of said workpiece is said reflecting waveguide.

10. The apparatus of claim 1 wherein said reflecting waveguide is both at least one surface of said workpiece and a separate reflecting waveguide.

11. The apparatus of claim 1 wherein said reflecting waveguide is made from a material selected from the group of: copper, alumina, ceramic, aluminum, silver, gold, silver plated material, and gold plated material.

12. The apparatus of claim 11 wherein said reflecting waveguide is made from copper.

13. The apparatus of claim 1 wherein said energy is infrared energy.

14. The apparatus of claim 1 wherein said energy source is a laser.

15. The apparatus of claim 14 wherein said energy source is a gas laser.

16. The apparatus of claim 14 wherein said energy source is a solid state laser.

17. The apparatus of claim 14 wherein said energy source is a diode laser.

18. The apparatus of claim 1 wherein said apparatus is in a processing chamber.

19. The apparatus of claim 18 wherein said processing chamber has an inlet, an outlet, and valves for atmosphere control.

20. The apparatus of claim 18 wherein said processing chamber has a temperature control mechanism.

21. The apparatus of claim 18 wherein said processing chamber has quartz windows.

22. The apparatus of claim 1 wherein said apparatus is a small portable apparatus.

23. A method for designing a reflecting waveguide and selecting a workpiece position in relation to said reflecting waveguide, said method comprising:
(a) determining the shape of said workpiece to be thermally treated or brazed;
(b) determining the shape of a braze joint and filler material;
(b) determining the time and temperature profile needed for the process;
(c) selecting an energy source which can provide the energy needed;
(d) selecting an approximated configuration for a reflecting waveguide;
(e) selecting an approximate placement of said workpiece in relation to said waveguide;
(f) entering data for (a), (b), (c), (d) and (e) into a computer model with ray tracing software;
(g) running said computer model to obtain a quantitative assessment of the energy flux distribution on said workpiece;
(h) entering selected variables in the configuration of said workpiece, the position of said workpiece, or the energy supplied into said computer model;
(i) running said computer model again to obtain another quantitative assessment of energy flux distribution on said workpiece; and
(j) reiterating steps (f) through (i) until a set of variables which will give the optimized energy flux distribution is determined.

24. The method of claim 23 further comprising:
(k) setting up work using the computer generated configuration for said reflecting waveguide, position of said workpiece, and energy profile; and
(l) performing said work.

25. The method of claim 24 wherein said work is performed by a method comprising:
(a) contacting said reflecting waveguide with energy from said energy source for a length of time necessary to perform said work;
(b) discontinuing contact of said reflecting waveguide with energy from said energy source.

26. The method of claim 25 wherein said work is a brazing process.

27. The method of claim 26 wherein said method further comprises applying brazing material to a joint to be brazed.

28. The method of claim 25 wherein said work is a heat treating process.

29. The method of claim 23 wherein a genetic algorithm is used for steps (i) and (j).

30. The method of claim 25 wherein said method is carried out in a processing chamber.

31. The method of claim 25 wherein said work is performed in a pressure controlled atmosphere.

32. The method of claim 25 wherein said work is performed in a temperature controlled atmosphere.

33. The method of claim 25 wherein said work is carried out in the presence of an inert gas.

34. The method of claim 24 wherein said reflecting waveguide is an integral part of said workpiece.

35. The method of claim 24 wherein said reflecting waveguide is both an integral part of said workpiece and a separate reflecting waveguide.

36. The method of claim 23 wherein said reflecting waveguide is selected from the group of V-shaped, conically-shaped, V-shaped with curved walls, conically-shaped with curved walls, and complex-shaped reflecting waveguides.

37. The method of claim 23 wherein said reflecting waveguide is made from a material selected from the group of: copper, alumina, ceramic, aluminum, silver, gold, silver plated material, and gold plated material.

38. The method of claim 37 wherein said reflecting waveguide is made from copper.

39. The method of claim 23 wherein said workpiece of one selected from the group of workpieces made of metal, ceramic, and combinations of metal and ceramic.

40. The method of claim 23 wherein said energy is infrared energy.

41. The method of claim 23 wherein said energy source is a laser.

42. The method of claim 25 wherein said workpiece is in situ, attached to part of an operating system.
